(19) United States
(12) Patent Application Publication
(10) Pub. No.: US 2008/0028033 A1
(43) Pub. Date: Jan. 31, 2008

(54) NETWORK DIRECTORY FILE STREAM CACHE AND ID LOOKUP

(75) Inventor: Benjamin A. Kendall, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/460,804

(22) Filed: Jul. 28, 2006

(51) Int. Cl. G06F 15/167

(52) U.S. Cl. 709/216

(57) ABSTRACT

Caching meta information including file relationships at a local processor. A local processor requests files and directories from the remote file system by sending a network identifier used by the remote file system. At the local processor, a network identifier is used to access a remote upper level directory at the remote file system. Meta information is obtained from the remote file system about files or directories hierarchically below the upper level directory. The meta information about the files or directories hierarchically below the upper level directory is cached along with relationship information about the files or directories without storing network identifiers for the files or directories. A network identifier is cached or known for a directory hierarchically above the files or directories that can be used to obtain the network identifiers for desired files or directories from the remote file system.

### BACKGROUND

### Background and Relevant Art

Computers and computing systems have affected nearly every aspect of modern living. Computers are generally involved in work, recreation, healthcare, transportation, entertainment, household management, etc. As computers become more widely used, digital data also becomes more prevalent and more desirable. For example, digital data can be used to represent audio and video signals. Music on CDs is stored digitally. Audio and video on DVDs is also stored digitally. Television signals provided over cable and satellite systems is generally provided in a digital format. In many areas, digitally encoded television signals can even be received from traditional over the air (OTA) broadcasters that have previously only broadcast analog signals.

Because this data can be stored digitally, individuals have begun using media servers where audio, video, and image data is stored on a computer system, central server or other central storage. This allows the user to have a repository of multimedia data. The user can then play or display the multimedia data directly from the computer, or send the data over the network to another computer or multimedia player through a network connection.

Often a media server will store a large number of files. To select a file to access, a user at a multimedia player must have some indication of the files at the media server. This often requires a transfer across a network of information about the files on the media server to the multimedia player. Because of the large number of files stored at the media server, information about all files stored at the server is not sent to the multimedia player prior to displaying the information about the media files to a user. Instead, as a user tries to request a portion of data describing the media files, the data describing the media files is sent from the media server to the multimedia adapter. Due to network traffic and congestion or bandwidth limitations on the network, some latencies may be experienced by a user as they attempt to page through a directory of media titles.

Typically, a multimedia player is embodied as an embedded system. An embedded system, typically has a fixed amount of resources such as a fixed RAM, fixed flash ROM, etc. As such, resources on an embedded system are typically limited as compared to other configurable systems.

The subject matter claimed herein is not limited to embodiments that solve any disadvantages or that operate only in environments such as those described above. Rather, this background is only provided to illustrate one exemplary technology area where some embodiments described herein may be practiced.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described further herein relates to a method that may be practiced in a computing environment including a local processor connected to a remote file system through a network connection. The local processor requests files and directories from the remote file system by sending a network identifier understandable by the remote file system to the remote file system. The method includes acts for caching meta information including file relationships at the local processor. At the local processor, a network identifier is used to access a remote upper level directory at the remote file system. Some of the meta information is obtained from the remote file system about one or more files or directories hierarchically below the upper level directory. The meta information about the one or more files or directories hierarchically below the upper level directory is cached. Relationship information about the one or more files or directories is cached without storing network identifiers for the one or more files or directories. A network identifier is cached or known for a directory hierarchically above the one or more files or directories. The network identifier for the directory hierarchically above the one or more files or directories can be used to obtain the network identifiers for the one or more files or directories from the remote file system.

In another embodiment, a method of accessing files or directories at the remote file system by a local processor is illustrated. Cached data about a desired file or directory is accessed. It is determined if the cached data about the desired file or directory includes a network identifier usable to retrieve the desired file or directory from the remote file system. If the cached data about the desired file or directory includes a network identifier usable to retrieve the desired file or directory from the remote file system, the desired file or directory is requested using the network identifier. If the cached data about the desired file or directory does not include a network identifier usable to retrieve the desired file or directory from the remote file system, information about a directory closer hierarchically to a root directory is accessed to obtain a network identifier for the higher directory. Accessing information about a directory closer hierarchically to a root directory is repeated until a network identifier is found. The obtained network identifier is used to retrieve a network identifier for the desired file or directory.

In another embodiment, a data structure for caching meta information including file relationships at a local processor is illustrated. The data structure includes a first field at a local processor. The first field includes meta information for an upper level directory. The meta information in the first field includes a network identifier for an upper level directory, where the network identifier is usable to access the upper level directory at a remote file system. The data structure further includes a second field. The second field comprises cached meta information about one or more files or directories hierarchically below the upper level directory, wherein the meta information includes relationship information about the one or more files or directories to the upper level directory without storing network identifiers for the one or more files or directories, but wherein the network identifier for the upper level directory can be used to obtain the network identifiers for the one or more files or directories from the remote file system

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an overview of a system for delivering media content to users;

FIG. 2 illustrates a block-diagram of a media player;

FIG. 3 illustrates a dynamic file system; and

FIG. 4 illustrate cached meta information including file and directory relationships.

### DETAILED DESCRIPTION

Embodiments herein may comprise a special purpose or general-purpose computer including various computer hardware, as discussed in greater detail below.

Some embodiments described herein use a caching system whereby meta information is stored about files and directories instead of the files and directories themselves, where the meta information includes information defining relationships between different files and directories. This information may be stored locally, such as for example at a processor in an embedded system, such as for example, in a digital media player. The information describes hierarchical file arrangements at a remote content server. Additionally, to conserve memory at the local processor, the amount of relationship information can be limited. For example, in one embodiment instead of storing a network identifier, which allows the local processor to directly request a file or directory from the remote file server, a less memory intensive local identifier is stored at the local processor where the local identifier identifies a file or directory locally. The file or directory may be related hierarchically to a higher level directory for which the network identifier is stored locally. As such, relationship information can be traversed locally until a directory hierarchically above a desired file or directory is found where the higher up directory information includes a network identifier. The networked identifier can then be used to contact the remote file server to obtain a network identifier for the desired file or folder.

In some embodiments, iterative processes may be performed locally both for locating network identifiers for higher level directories and once a higher level directory with a network identifier is found, locating the network identifier for the lower level desired file or directory. Specifically, to find a network identifier locally, higher level directory meta information is checked for a network identifier. If that higher level directory meta information does not have a network identifier, even higher level still directory meta information is checked for a network identifier. This process is repeated until a network identifier for a directory hierarchically above the desired file or network is found. Once a network identifier is found, the network identifier is used to contact a remote file server to find a lower level directory or file, where the processes may be repeated on even lower level directories or files until the desired directory or file network identifier is retrieved from the remote file server.

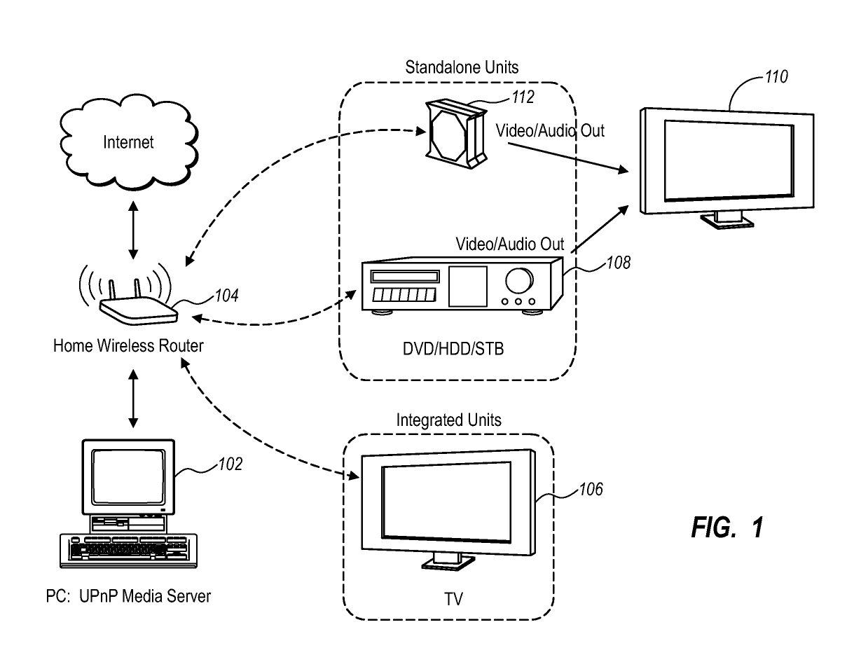

The following description illustrates one embodiment where principles of the present invention may be practiced. Referring now to FIG. 1, an exemplary environment where some embodiments of the invention may be practiced is illustrated. FIG. 1 illustrates a media server 102, which in this example is a universal plug and play (UPnP) server. The media server 102 may store various media files such as music files, video files, and picture files. Generally, the media server 102 is located in a local area network (LAN) and configured to provide the media files locally to clients. For example, in one embodiment, the media server 102 may be implemented in a home environment to provide media to home users. The file system storing media files and directories in the media server 102 may be a remote file system with respect to client computing devices as discussed in more detail below.

The media server 102 is connected through a router 104 to various clients on the network. The clients on the network may include specialized media adapters configured to provide media to users. As will be discussed further herein, the media adapters may include specialized hardware optimized for providing the media to users. For example, the media adapters may include processors that are optimized for decoding compressed audio, video or image data. The media adaptors may be embodied in a number of forms as illustrated in FIG. 1. For example, FIG. 1 illustrates an integrated media adapter integrated into a television 106. With this configuration, there is no need for an external box including the media adapter because the media adapter is integrated into the television where the media will be displayed or played.

FIG. 1 also illustrates a number of standalone units. For example, the media adapter may be integrated into a DVD player 108. This embodiment is particularly interesting as often the encoding typical on DVDs is the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further illustrates a self contained media adapter 112. The self contained media adapter 112 includes the specialized hardware for decoding and displaying media streamed from the media server 102. The self contained media adapter 112 is connected to the television 110 through audio and video connections.

Each of the examples of media adapters whether embodied in an integrated unit such as with the television 106, or a standalone unit such as the DVD player 108 or self contained media adapter 112, or other media adapter is connected, in this example, through the router 104 to the media server 102. The connections between the media server 102, router 104 and media adapters may be any suitable network connection including hardwired Ethernet connections, wireless wi-fi connections, or any other suitable connection. Notably some embodiments described herein optimize wireless network connections to maintain suitability for transmitting high bit rate media files.

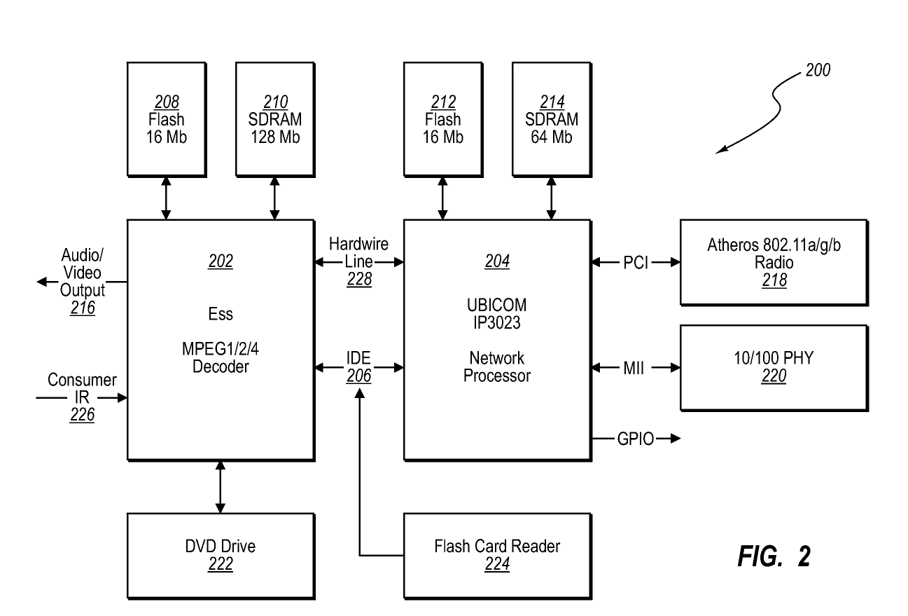

Referring now to FIG. 2, hardware from the media adapter is illustrated. As described previously, the media adapter 200 includes two processors coupled by an IDE bus. While an IDE bus is illustrated here, other storage device type busses may also be used. Additionally, embodiments may be implemented on single processor systems as well. The media adapter 200 includes an mpeg decoder processor 202 coupled to a network processor 204 through an IDE bus 206. Each of the processors 202, 204 includes other appropriate peripheral hardware. For example, the decoder processor 202 is coupled to flash memory 208 and DRAM memory 210. The flash memory and DRAM memory 210 may store computer executable instructions such as computer applications to be executed on the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, etc.

Similar to the decoder processor 202, the network processor 204 has a flash memory 212 and a DRAM memory 214 connected to it. The flash memory 212 and DRAM memory 214 are computer readable media that may include computer executable instructions that can be executed by the network processor 204. In addition, the DRAM memory 214 may store data for delivery to the decoder processor 202. For example, the network processor 204 may receive data from a data store such as a media server, such as the media server 102. This data may be stored in the DRAM memory 214 for delivery to the decoder processor 202. Such data may include for example, media, file information, directory information, or other information. In one exemplary embodiment, the DRAM memory 214 may be used to cache meta information including file relationship information as will be explained in more detail below. Similary, single processor embodiments may be implemented where the single processor includes an attached SDRAM or other memory for storing cached meta information including file relationship information. In the example illustrated, the network processor 204 may be connected to a media server through one or more different network connections.

FIG. 2 illustrates both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further illustrates that the network processor 204 may communicate with the media server through a wired connection such as by using a standard 10/100 Mbs (megabits per second) Ethernet adapter 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 illustrates two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is illustrated in FIG. 1 at 108.

FIG. 2 illustrates a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive. Any one of a number of removable and non-removable storage devices may be connected locally to the IDE bus 206 including but not limited to secure digital (SD) flash cards, compact flash (CF) flash cards, xD flash cards, on-board flash memory, on-board SRAM, on-board DRAM, IDE hard disk drives and the like.

Ordinarily, a storage device connected to a host processor through an IDE bus is somewhat passive in nature. In other words, typically the IDE device accepts commands from the host processor, and can be polled by the host processor for information, but does not typically provide data to the host processor without first being prompted. In the example shown in FIG. 2, the decoder processor 202 assumes the role of the processor and the network processor 204 assumes the role of the device in the IDE connection. To facilitate the network processor 204 providing information to the decoder processor 202, a hardware line 228 connects the two processors. If the network processor 204 has information to pass to the decoder processor 202, the network processor 204 can set the line signaling to the decoder processor 202 that the network processor 204 has information to pass to the decoder processor 202. The decoder processor 202 can then poll the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 polls the network processor 204, the network processor 204 can provide the diagnostic information.

To retrieve directory and file information, the decoder processor 202 requests data from the network processor 204 using the IDE interface 206. As such, the decoder processor 202 requests the data by providing an address and requesting a read from that address. Some embodiments described herein may implement a virtual address mapping that allows the decoder processor 202 to use a shared address range along with an address corresponding to a file and/or directory identifier to access data using typical IDE file access techniques. Examples of this virtual mapping are described in U.S. patent application Ser. No. 11/460,375 filed on Jul. 27, 2006 titled “Dynamic Stream File System Network Support” which is incorporated herein by reference in its entirety. Partial details of one embodiment of virtual mapping are described herein below.

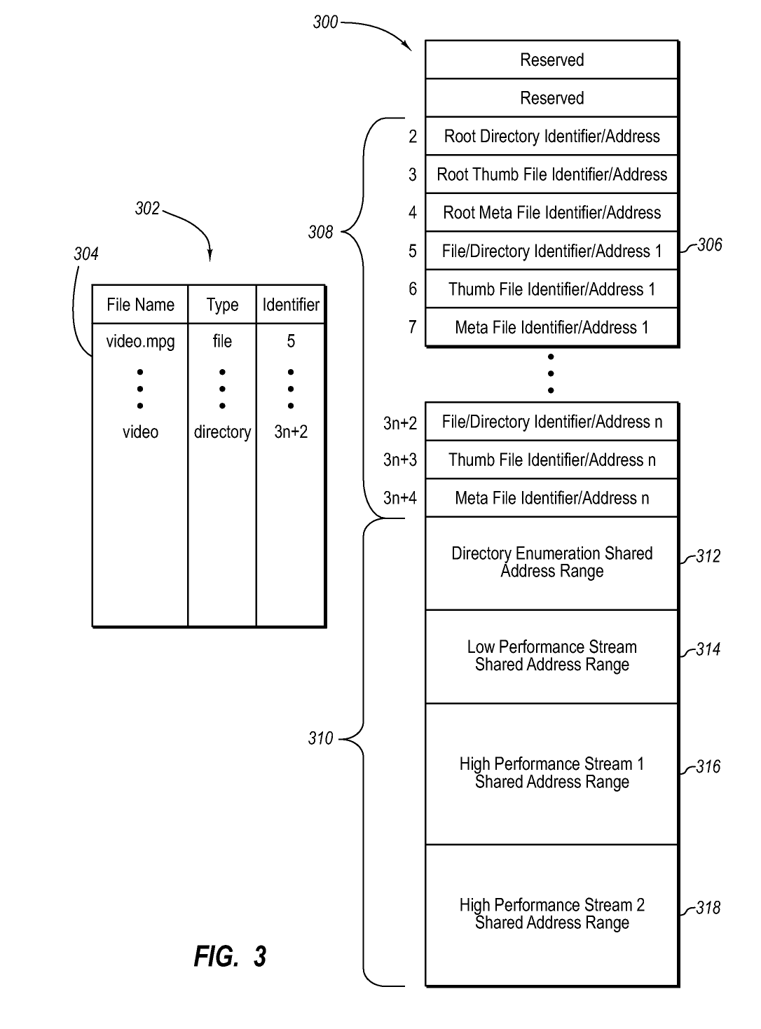

Referring now to FIG. 3, a block diagram illustrating a file space address map 300 is shown. In one embodiment, the file space address map 300 is a virtual address map implemented in the network processor 204 shown in FIG. 2. The file space address map 300 includes a virtual mapping of addresses for files and directories. To accomplish this, a first portion 308 of the file space address map 300 virtually correlates file and/or directory identifiers with status information and shared address mapping. The first portion 308 can also be used to map additional information such as thumbnail file identifiers and addresses and metadata file identifiers and address corresponding to the file and/or directory identifiers. The second portion 310 of the file space address map 300 has shared address ranges which can be used by the decoder processor 202 to access content from a content location, such as a remote media server 102 (FIG. 1) or from a local storage device such as a flash drive connected at the flash card reader 224 (FIG. 2) for accessing files and directories. In particular, the second portion 310 includes four address ranges. The four address ranges are fixed in address and size such that the decoder processor 202 may specify the same address for two different files. The network processor 204 is able to later determine, based on a previous request for information from the decoder processor 202 to the network processor, which file is actually being requested.

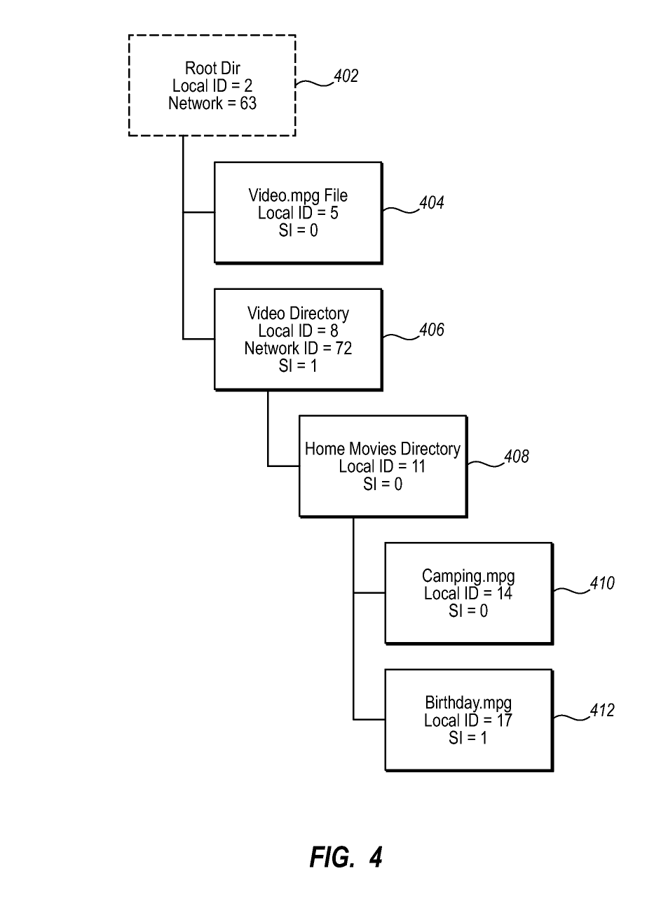

Associated with the file space address map 300 is a directory enumeration 302. The directory enumeration 302 includes entries for files and directories. The directory enumeration 302 may be located, for example, in the DRAM 210 connected to the decoder processor 202, the DRAM of the network processor 204, and/or in the DRAM of a single processor system. Entries in the directory enumeration 302 include a file name (or directory name), a type (i.e. an indicator that the entry is for a file or directory), and an identifier. For example, FIG. 3 illustrates the first entry 304 in the directory enumeration 302. The first entry 304 in the directory enumeration 302 includes a file name, which in this case is “Video.mpg”, a type indicator which in this case indicates that the file “Video.mpg” is a file, and an identifier which in this case is 5. The identifier can be mathematically converted to an IDE compatible address which is one of the virtual addresses in the file space address map 300. As will be described with reference to FIG. 4 below, the information in the directory enumeration may be cached along with file relationship information to allow for quick access to a remote file system, such as the UPnP server 102 by using the shared address mapping and virtual file structure illustrated in the file space address map 300. It should be appreciated however, that embodiments may be implemented where the virtual file structure illustrated in the file space address map is not used. The file space address map 300 is only exemplary, and embodiments may be implemented where direct access to a remote file system is contemplated.

FIG. 3 illustrates that the file space address map 300 has the Root Directory Identifier/Address stored in a location corresponding to the identifier 2 of the file space address map 300. Notably, no corresponding entry is included in the directory enumeration 302. In the present example, the identifier for the Root Directory Identifier/Address is well known and known to be at the location corresponding to the identifier 2. This allows the decoder processor 202 to access the virtual file system at the network processor 204 to enumerate information in the directory enumeration 302 at start-up. Stated differently, the information in the directory enumeration 302 is populated by retrieving directory information from the network processor 204. This can be done by using information in the directory enumeration 302. However, at startup, there is no information in the directory enumeration 302 for the decoder processor to use to retrieve directory information from the network processor 204. This is not a problem, however, because the identifier for the root directory is well known, and as such, the network processor does not need to reference the directory enumeration 302 to obtain the identifier, but can rather simply convert the identifier for the root directory, in this case 2, to the appropriate IDE address, which will be used to populate the directory enumeration 302 with root directory entries. Notably, a well known identifier and/or address may be used for the root directory, or for that matter any directory or file, in embodiments whether or not the virtual file system is implemented.

Other memory saving techniques, as discussed in more detail below, are also used. For example, it can be observed in FIG. 3 in one embodiment, each file or directory identifier/address has associated thumb file identifiers and addresses and associated meta file identifiers and addresses. Rather than storing file name, file type, and an identifier in the directory enumeration 302, the identifier can be deduced from assumptions. In particular, the identifier for the thumb file address in this example is m+1 and the identifier for the meta file address is m+2 where m is the identifier for the file or directory associated with the thumb file and the meta file. Thus, in one embodiment, the directory enumeration 302 includes file and directory identifiers explicitly, but thumb file identifiers and meta file identifiers are only included implicitly. While the example illustrated above includes a relationship where meta file identifiers and thumb file identifiers appear as subsequent identifiers to a related file or directory, other relationships may also be used.

Directories can be opened for enumeration in directory enumeration 302. One functional example of directory enumeration will now be illustrated. This example will begin assuming that no data exists in the directory enumeration 302. In one example, the media adapter 200 may be just been turned on or reset. The decoder processor 202 knows that root directory identifier is 2. The decoder processor 202 converts this identifier to a virtual address in the file space address map 300. Notably, similar techniques may be used with real file space address mapping. The decoder processor 202 then issues and IDE read request to the network processor 204 to read the calculated virtual address.

The network processor 204 then performs a virtual read of the calculated address. In the illustrated example, because only a single shared address range is used for directory addresses, namely the directory enumeration shared address range 312, any virtual read of a calculated address for a directory will result in the address range for the directory enumeration shared address range 312 being returned. Thus, the network processor 204 returns as a response to the decoder processors 202 read request, the address range for the directory enumeration shared address range 312. The decoder processor 202 can use this shared address range 312 to request directory information from the root directory to enumerate directory information into the directory enumeration 302. Because the decoder processor had previously requested a shared address range by reading the calculated address for the root directory, subsequent read requests to the directory enumeration shared address range 312 will result in information for the root directory being returned from the network processor 204 to the decoder processor. In particular, the network processor includes a data structure that correlates identifiers with network identifiers. The network identifier may be, for example, a serial number, URI, path or other identifier for a particular directory or file that is known by both the network processor 204 and a data server such as the UPnP media server 102. Thus, when a directory is open for enumeration, the network processor 204 will use the network identifier to obtain data from the UPnP server 102. Notably, with only a single directory enumeration shared address range 312, in the illustrated embodiment, only a single directory is open for enumeration at any given time. If a new directory is opened for enumeration, then the previously opened directory is closed.

Once a portion of a directory has been enumerated in the directory enumeration 302, the information in the directory enumeration 302 may be used to open other directories for enumeration. It should be noted at this point that the directory enumeration 302 does not necessarily contain the entire enumeration of the directory, but rather may be a predetermined amount for the directory up to some maximum. For example, the directory enumeration 302 may only store a maximum of 80 entries. Returning now to the present example, the directory enumeration 302 illustrates a directory titled “video” with an identifier of 3n+2. This identifier can be converted to the corresponding virtual address in the file space address map 300 shown in the first portion 308 and labeled 3n+2. This address space contains a virtual mapping to the directory enumeration shared address range 312 which is again returned to the decoder processor as the response to the request to read the address corresponding to 3n+2. Notably, this is the same response as for the root directory, however the network processor now knows that the directory “video” is open for enumeration instead of the root directory. Addresses within the virtual directory enumeration shared address range 312 can be used by the decoder processor 202 to request directory information for the “Video” directory until another directory is opened for enumeration.

When directory information is enumerated, some of the information may be cached in a fashion that allows for quick access to actual files and directories while still conserving valuable memory. Examples are illustrated below.

Referring now to FIG. 4, cached file information is illustrated. In the example illustrated in FIG. 4, various pieces of information are cached including directory or file names, local identifiers, directory network sub-indexes and optionally network identifiers. Additionally, the cache includes relationship information to relate files hierarchically to one another. The information shown being cached is only exemplary and other information may be cached as well including information such as attributes, creation date, file system unique identifier, etc. Some of the items are cached by implication as illustrated by elements shown in phantom in FIG. 4. For example, information about the root directory 402 is well known and as such the information does not need to be explicitly cached in a cache. Additionally, some information about thumb files and meta files may be readily calculatable and thus may not need to be cached explicitly. As explained previously herein, in one embodiment, a thumbnail will have the next subsequent local identifier subsequent to the directory or file the thumbnail file is for. Similarly, a meta file for the particular file will have the next local identifier subsequent to the thumbnail file for the particular file.

Notably, FIG. 4 illustrates that less information is cached for some items than for other items. For example, for the “Video” directory meta information at 406 both a local identifier and a network identifier are cached. While in this example, the network identifier is illustrated as a simple number, typically a network identifier will be a uniform resource identifier (URI) that may include a significant amount of information to identify a remote storage server and a path on the remote storage server identifying where the actual file or directory content can be obtained. Thus, to conserve memory resources, cached information for some items excludes the network identifier and only includes the local identifier.

A method of creating the cached information shown in FIG. 4 will now be explained. The method may be practiced, for example, in a computing environment including a local processor connected to a remote file system through a network connection. The local processor requests files and directories from the remote file system by sending a network identifier understandable by the remote file system to the remote file system. The method includes acts for caching metadata and file relationships. A network identifier is used to access a remote upper level directory. For example, as explained previously, at the network processor 204, the network identifier for the root directory may be well known. This network identifier, in this case illustrated as 63 in FIG. 4, may be used to access a remote file system, such as the UPnP server 102 illustrated in FIG. 1.

Meta information can be obtained about one or more files or directories hierarchically below the upper level directory. For example, by accessing the UPnP server 102, the network processor; can query the UPnP server 102 for information contained in the root directory at the UPnP server 102. In the example shown in FIG. 4, meta information, illustrated at 404, can be obtained for the file “Video.mpg” and the “Video” directory illustrated at 406. In the example shown, at least the file name and network sub index are obtained as meta information for “Video.mpg”. For the “Video” directory, meta information illustrated at 406 includes the directory name, a network identifier and a network sub index. As explained previously, other meta information may also be retrieved from a remote file server, such as attributes, creation date, network identifier, etc.

One or more local identifiers can be assigned for the one or more files or directories hierarchically below the upper level directory. For example, in FIG. 4, local identifier 5 is assigned to the file video.mpg. Local identifier 8 is assigned to the directory “Video.” Notably, and as explained previously, in the present example, the two next local identifiers after any file or directory are reserved for thumbnail and meta files.

The meta information can be cached. For example, FIG. 4 illustrates cached meta information. The meta information may be cached, for example, at the SDRAM 214 at the network processor 204 shown in FIG. 2. Additionally, relationship information about the one or more files or directories may be cached with the meta information without storing network identifiers for the one or more files or directories. For example, the cached information in FIG. 4 illustrates that the file “Video.mpg” illustrated at 404 is a child of the root directory. However, the network identifier for “Video.mpg” is not cached in the cache. Similarly, the directory “Home Movies” illustrated at 408 is a child of the directory “Video” illustrated at 406. However, no network identifier is stored of the “Home Movies” directory. Embodiments may also be implemented where network identifiers are not included for several hierarchical levels. For example, for the videos “Camping.mpg” illustrated at 410 and “Birthday.mpg” illustrated at 412, no network identifier is stored. Nor is an identifier stored for the directory “Home Movies” which is one level above the “Camping.mpg” and “Birthday.mpg” videos. At one level above the “Home Movies” directory, is the “Video” directory illustrated at 406. The meta information for the “Video” directory includes a network identifier, in this case, 72. This network identifier can be used to obtain network identifiers for the “Home Movies” directory and the “Canping.mpg” and “Birthday.mpg” videos as will be explained in more detail below.

Notably, in the embodiments illustrated in FIGS. 1-4, the cached information may be used by the decoder processor 202 to both display information to a user so that a user can then select a directory or file to view, and so that the decoder processor 202 can request data from the network processor, which is then requested from a file store, such as the UPnP server 102. In particular, a sufficient amount of meta information including relationship information is cached such that a user can browse the cached information as if browsing a file tree on the remote file server itself. As such, several features may be implemented to facilitate a better user experience.

For example, in one embodiment, caching may be performed in a predictive fashion such that information more likely to be requested by a user is cached. In particular, if information is requested by a user, and the information is not in cache, then the information is requested over a network connection by the network processor 204 from the remote file system. This can result in delays caused by having to request the data over the network. To make this occurrence less frequent, algorithms may be implemented whereby meta information that is most likely to be requested is cached.

Another feature that may be implemented is a feature whereby the cache at the local processor can be flushed by another local processor. For example, if the cache is stored at the SDRAM 214 of the network processor 204, and the network processor receives a notice from the UPnP server that items have changed on the UPnP server, the network processor can indicate to the decoder processor 202 that the cached meta information at the network processor 204 may be invalid. The decoder processor 202 can then notify the network processor to flush the cache. The network processor 204 can then flush the cache. This communication between the network processor 204 and the decoder processor is done to ensure that the decoder processor does not attempt to access data using outdated address information. In particular, if the decoder processor 202 attempts to use the local identifiers assigned to files and directories after data has changed for those files and directories on the remote file storage, the local identifiers may no longer correspond to the appropriate file or directory. Thus, by flushing the cache and assigning new local identifiers, mapping relationships can be restored.

Embodiments herein further allow for cached meta information to be used to access remote files and directories. For example, one embodiment may be practiced in a computing environment including a local processor connected to a remote file system through a network connection. The local processor requests files and directories from the remote file system by sending a network identifier understandable by the remote file system to the remote file system. The method includes acts for accessing files or directories at the remote file system by the local processor. The method includes accessing cached data about a desired file or directory. For example, a user using a digital media player may have a desire to retrieve the file “Camping.mpg” represented in the cached data at 410. As such, the cached data at 410 may be accessed.

Next, it may be determined if the cached data about the desired file or directory includes a network identifier usable to retrieve the desired file or directory from the remote file system. In particular, in the present example, the cached data at 410 would be checked for a network identifier. If the cached data about the desired file or directory includes a network identifier usable to retrieve the desired file or directory from the remote file system, the desired file or directory is requested using the network identifier. In this case, no network identifier is included in the cached data at 410.

If the cached data about the desired file or directory does not include a network identifier usable to retrieve the desired file or directory from the remote file system, a network identifier can be located to obtain the network identifier for the desired file or directory. For example, in one embodiment, information about a directory closer hierarchically to a root directory than the desired file or directory may be accessed to obtain a network identifier. This may be done iteratively such that accessing information about a directory closer hierarchically to a root directory is repeated until a network identifier is found. For example, in the present illustration, the “Home Movies” directory with cached information illustrated at 408 is closer to a root directory in the hierarchy than the “Camping.mpg” video whose cached information is illustrated at 410. Thus, the “Home Movies” directory meta information 408 may be checked for a network identifier. In this example, the “Home Movies” directory meta information 408 does not include a network identifier, and as such, another iteration is performed whereby meta information for a directory closer to the root is referenced. In the present example, the “Video” directory meta information 406 is referenced. The “Video” directory meta information 406 includes a network identifier.

The obtained network identifier is used to retrieve a network identifier for the desired file or directory. In one embodiment, this may be performed in a fashion similar, but in reverse, to the process for obtaining a network identifier. In particular, using the obtained network identifier to retrieve a network identifier for the desired file or directory may include iteratively obtaining a network identifier for an upper level directory followed by using the network identifier for the upper level directory to access a file or directory one level below the upper level directory. For example, if the network processor has the network identifier for the “Video” directory, the network processor 204 can access the “Video” directory on the remote file server, in this case the UPnP server 102. The network processor 203 can then request the network identifier for the “Home Movies” directory. The network identifier for the “Home Movies” directory can then be used to access the network identifier for the “Camping.mpg” video, which can then be retrieved and delivered to the user.

Specifically, in one embodiment, the network processor can iteratively use the network identifier and network sub index of a next directory or file to obtain a network identifier for a desired file. Illustrating now a specific example, the network identifier for the “Video” directory is known by referencing the cached information 406 at the network processor. This can be used, along with the network sub index cached in the “Home Movies” meta information 408 to obtain the network identifier for the “Home Movies” directory from a remote file system, such as the UPnP server 102. Next, the obtained network identifier for the “Home Movies” directory, along with the network sub index cached at the meta information 410 for the “Camping.mpg” video can be used to obtain the network identifier for the “Camping.mpg” video from the remote file system. The network identifier for the “Camping.mpg” video can be used to access the “Camping.mpg” video from the remote file system.

While in the embodiments illustrated above, accessing information about a directory closer hierarchically to a root directory is illustrates as accessing cached data about a directory, other embodiments may also be implemented. For example, as illustrated in FIG. 4, the meta information, including the network identifier for the root directory illustrated at 402 is well known. As such, accessing information about a directory closer hierarchically to a root directory may include accessing well known information about a directory. Additionally, the directory closer to the root directory may be the root directory itself.

Support for thumbnail files and metadata files may also be included in some embodiments. This allows for improved performance, and increased informational data available to a user.

In one embodiment, all thumbnail files are JPEG files. While typically the thumbnail files are stored on the remote file system, some thumbnail files may be persistently stored locally. For example, a thumbnail file depicting a directory folder or a frequently used directory folder may be stored in flash memory such as flash memory 221 illustrated in FIG. 2 and available in the media adapter 200. For example, default JPEG files for directories (folder.jpg), videos (video.jpg), music (music.jpg), and config (config.jpg) can be stored in the network processor 204 flash memory 212 and made locally available.

In one embodiment, metadata files are simple XML files containing tagged metadata information. This allows future compatibility and extensibility. Default metadata file templates for directories (folder.mta), videos (video.mta), music (music.mta), and config (config.mta) can be stored, for example, in the network processor 204 flash file system 212 and made locally available.

File info structures stored in the cache may take into account the thumbnail and metadata file information.

As enumeration of directory contents over a network can be time consuming, methods to cache related information as part of the enumeration process can be employed. For example, as directory contents are enumerated, a file list is populated with information describing the contents of the directory. Thumbnail and metadata information may be included to relate the enumerated file with its corresponding thumbnail and metadata files. For example, in one embodiment, the thumbnail and metadata information may be logically offset from an enumerated file. For example, the “Video.mpg” file has a local identifier of 5. The associated thumbnail and metadata files may have local identifiers of 6 and 7 respectively. While the thumbnail and metadata files may be represented as a logical offset to a specific identifier, this may not always be the case.

Notably, as actual file information becomes available, the actual file address, thumbnail address and metadata address may be stored in a data representation later accessed by the decoder processor 202. By doing so, the processor instructions may determine optimal access address without having to enumerate the directory contents again.

The data representation may be sized according to memory requirements on a particular system. For example, in the particular example shown, actual network identifiers are stored for up to 1000 cache entries.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. In particular, while the embodiments have been described with respect to a digital media player environment, it should be understood that the invention can be implemented in other environments as well. In particular, and without limitation, many embedded systems of varying functionality could benefit from embodiments of the invention. The invention however is not limited in its scope to only embedded systems. Rather, the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including a local processor connected to a remote file system through a network connection, wherein the local processor requests files and directories from the remote file system by sending a network identifier understandable by the remote file system to the remote file system, a method of caching meta information including file relationships at the local processor, the method comprising:
at the local processor, using a network identifier, accessing a remote upper level directory at the remote file system;
at the local processor, obtaining meta information from the remote file system about one or more files or directories hierarchically below the upper level directory;
at the local processor, caching the meta information about the one or more files or directories hierarchically below the upper level directory; and
at the local processor, caching relationship information about the one or more files or directories without storing network identifiers for the one or more files or directories, but wherein a network identifier is cached or known for a directory hierarchically above the one or more files or directories, where the network identifier for the directory hierarchically above the one or more files or directories can be used to obtain the network identifiers for the one or more files or directories from the remote file system.

2. The method of claim 1, wherein the meta information about one or more files or directories comprises a file or directory name.

3. The method of claim 1, further comprising implicitly caching relationship information relating the one or more files or directories to meta files or thumbnail files at the remote file system by calculating local identifiers for the one or more meta files or thumbnail files based one or more local identifiers for the one or more files or directories.

4. The method of claim 1, wherein the remote file system is comprised of a Universal Plug and Play Server.

5. The method of claim 1, wherein the local processor is a network processor at a digital media player.

6. The method of claim 5, further comprising:
receiving an indication from the remote file system that data has changed on the remote file system;
sending a message to a decoder processor at the digital media player that a cache including the file relationship information may be invalid;
receiving a message from the decoder processor at the digital media player to flush the cache; and
flushing the cache.

7. The method of claim 1, wherein caching the meta information and the relationship information is performed in a predictive fashion such that information more likely to be requested by a user is cached.

8. The method of claim 1, further comprising caching thumbnail files persistently for frequently used folders.

9. The method of claim 8, wherein caching thumbnail files persistently comprises storing the thumbnail files in a local flash memory.

10. In a computing environment including a local processor connected to a remote file system through a network connection, wherein the local processor requests files and directories from the remote file system by sending a network identifier understandable by the remote file system to the remote file system, a method of accessing files or directories at the remote file system by the local processor, the method comprising:
accessing cached data about a desired file or directory;
determining if the cached data about the desired file or directory includes a network identifier usable to retrieve the desired file or directory from the remote file system;
if the cached data about the desired file or directory includes a network identifier usable to retrieve the desired file or directory from the remote file system, requesting the desired file or directory using the network identifier; and
if the cached data about the desired file or directory does not include a network identifier usable to retrieve the desired file or directory from the remote file system:
accessing information about a directory closer hierarchically to a root directory to obtain a network identifier, wherein accessing information about a directory closer hierarchically to a root directory is repeated until a network identifier is found; and
using the obtained network identifier to retrieve a network identifier for the desired file or directory.

11. The method of claim 10, wherein accessing information about a directory closer hierarchically to a root directory comprises accessing cached data about a directory.

12. The method of claim 10, wherein accessing information about a directory closer hierarchically to a root directory comprises accessing well known information about a directory.

13. The method of claim 10, wherein using the obtained network identifier to retrieve a network identifier for the desired file or directory comprises iteratively obtaining a network identifier for an upper level directory followed by using the network identifier for the upper level directory to access a file or directory one level below the upper level directory.

14. The method of claim 13, further comprising iteratively using network identifiers for upper level directories to access a file or directory one level below the upper level directory until a desired file or directory network identifier is accessed.

15. The method of claim 10, wherein accessing information about a directory closer hierarchically to a root directory to obtain a network identifier comprises accessing information one level closer.

16. In a computing environment including a local processor connected to a remote file system through a network connection, wherein the local processor requests files and directories from the remote file system by sending a network identifier understandable by the remote file system to the remote file system, a data structure for caching meta information including file relationships at the local processor, the data structure comprising:
a first field at a local processor, wherein the first field comprises meta information for an upper level directory, wherein the meta information in the first field comprises a network identifier for an upper level directory, the network identifier usable to access the upper level directory at a remote file system;
a second field, wherein the second field comprises cached meta information about one or more files or directories hierarchically below the upper level directory, wherein the meta information includes relationship information about the one or more files or directories to the upper level directory without storing network identifiers for the one or more files or directories, but wherein the network identifier for the upper level directory can be used to obtain the network identifiers for the one or more files or directories from the remote file system.

17. The data structure of claim 16, wherein the first field is comprised of well known information.

18. The data structure of claim 16, wherein the first field is comprised of cached information in a cache.

19. The data structure of claim 16, wherein the second field includes cached meta information about at least one of a thumbnail file or metadata file, wherein the thumbnail file or metadata file can be identified locally by calculating a local identifier from a local identifier for a file or directory for which meta information is stored in the data structure.

20. The data structure of claim 16, further comprising a third field comprising one or more persistently cached thumbnail files.
